(19) United States
(12) Patent Application Publication
(10) Pub. No.: US 2011/0143316 A1
(43) Pub. Date: Jun. 16, 2011

(54) DENTAL IMPLANT DRIVER AND CARRIER REMOVAL SYSTEM

(75) Inventors: Matthew K. Olson, Farmington, CT (US); Clifford W. Olson, Easton, CT (US)

(73) Assignee: Designed Dental Systems LLC, Farmington, CT (US)

(21) Appl. No.: 12/962,984

(22) Filed: Dec. 8, 2010

Related U.S. Application Data
(60) Provisional application No. 61/283,842, filed on Dec. 10, 2009.

(51) Int. Cl. A61C 8/00

(52) U.S. Cl. 433/147

(57) ABSTRACT

The present invention is directed to a tool package for use with bone and/or dental implant systems. The tool package includes of two mating tools. The first tool is designed to engage an implant and carrier assembly and place the implant into the osteotomy. Once the implant is fully seated, the first tool is removed. The second tool is placed over the implant to hold the implant securely in place. The first tool is reintroduced through the second tool to engage and remove the implant carrier. The first tool may function like screwdriver except that the tip is able to mate with and positively engage the octagonal implant carrier head and plastic o-ring catch. The first tool drives the implants into place, and also mates with the second tool to remove the implant carrier.

### CROSS-REFERENCE TO RELATED APPLICATIONS

This application claims the benefit of U.S. Provisional Application No. 61/283,842 filed Dec. 10, 2009, which is hereby incorporated by reference in its entirety.

### TECHNICAL FIELD

The present invention is related to tools for use with implant systems, and more particularly to tools and a tool kit for use with dental implant systems.

### BACKGROUND OF THE INVENTION

Implants such as dental implants are inserted into areas of bone, osteotomy, by hand pieces or instrumentation. For example, the hand instrumentation may be a ratchet system that is awkward and time consuming to use. In addition, while one hand piece or instrumentation may be needed to insert the implant, another hand piece of instrumentation may be needed to engage with the implant in order to remove the implant carrier used by the first hand piece or instrumentation to insert the implant. The use of a second hand piece or instrumentation may take up already limited space, and make removal of the implant carrier awkward and difficult. Therefore, there is a need for better tactile feedback, control, and safety when installing dental implants and removing the implant carrier.

### SUMMARY OF THE INVENTION

An exemplary embodiment of the present invention is directed to a tool package for use with bone and/or dental implant systems. The tool package includes two mating tools. The first tool is a straight implant driver. It is designed to engage an implant and carrier assembly and place the implant into the osteotomy. Once the implant is fully seated, the implant driver is removed. The second tool, which acts like a wrench, is placed over the implant to hold the implant securely in place. The first tool is reintroduced through the second tool to engage and remove the implant carrier only. The first tool, the straight implant driver, looks and functions like a regular screwdriver except that the tip is able to mate with and positively engage the octagonal implant carrier head and plastic o-ring catch. The first tool drives the implants into place, and also mates with the second tool to remove the implant carrier in a faster, easier, and single plane process that is superior to currently existing and available tools. The first tool is also superior for tactile feedback while placing the implant, especially when expanding the osteotomy during the implant placement.

Another exemplary embodiment of the present invention is directed to a tool that includes a first end, a second end, a longitudinal axis, a body portion that includes an exterior casing and an interior region defined by a passage extending from the first end to the second end of the tool along the longitudinal axis. The passage includes a first section with a first cross-sectional diameter and a second section with a second cross-sectional diameter, and the first cross-sectional diameter is larger than the second cross-sectional diameter. The tool also includes an arrangement that includes at least one substantially flat surface positioned at the second end of the tool. The passage is dimensioned for insertion of a driver comprising a socket into the first end of the tool in a direction substantially parallel to the longitudinal axis of the tool, the passage is further dimensioned to allow the socket of the driver to be positioned substantially adjacent to the arrangement at the second end of the tool, and the passage is further dimensioned to allow the driver to rotate within the passage of the tool.

In accordance with this exemplary embodiment of the invention, the arrangement may include at least two substantially flat surfaces, and the at least two substantially flat surfaces may be separated by a groove. The arrangement may have a substantially hexagonal cross-section in a direction substantially perpendicular to the longitudinal axis of the tool. Adjacent edges the hexagonal cross-section of the arrangement may be connected by a segment of a circle. The groove may have a cross-sectional shape of a segment of a circle in a direction substantially perpendicular to the longitudinal axis of the tool.

In accordance with this exemplary embodiment of the invention, at least one substantially flat surface of the arrangement may originate at the second end of the tool and extends along the passage towards the first end of the tool.

In accordance with this exemplary embodiment of the invention, the passage may also include a third section that includes the arrangement and may have a third cross-sectional diameter smaller than the second cross-sectional diameter.

In accordance with this exemplary embodiment of the invention, the passage may also include a fourth section positioned between the first section and the second section, and the fourth section may be tapered to join the first section with the second section.

In accordance with this exemplary embodiment of the invention, the second section of the passage may be positioned substantially concentric with the first section of the passage along the longitudinal axis of the tool.

In accordance with this exemplary embodiment of the invention, the exterior casing may include a first substantially cylindrical region and a second substantially cylindrical region, and the first substantially cylindrical region may encompass at least the first section of the passage and the second substantially cylindrical region may encompass at least the second section of the passage. The first substantially cylindrical region may include at least one substantially flat surface and/or at least one substantially concave surface.

In accordance with this exemplary embodiment of the invention, the arrangement may be configured for engagement with a first plurality of contact surfaces of a fastener, and the socket of the driver may be configured for engagement with a second plurality of contact surface of the fastener. When the socket of the driver is positioned substantially adjacent to the arrangement at the second end of the tool, the arrangement may be configured to engage the first plurality of contact surfaces of the fastener while the socket may be configured to engage the second plurality of contact surfaces of the fastener.

In accordance with this exemplary embodiment of the invention, the driver may also include a driver handle, a driver longitudinal axis, and an elongated portion extending from the driver handle along the driver longitudinal axis.

In accordance with this exemplary embodiment of the invention, the socket of the driver may be positioned at an end of the elongated portion opposite the driver handle.

In accordance with this exemplary embodiment of the invention, the driver handle may have at least one substantially concave region.

In accordance with this exemplary embodiment of the invention, the socket of the driver may include an opening, a base positioned substantially opposite the opening, an octagonal portion extending from the base, and a ring portion at least partially defining an arc of the opening. The octagonal portion may have a substantially octagonal cross-section in a direction substantially perpendicular to the driver longitudinal axis of the driver, and adjacent edges the octagonal cross-section of the octagonal portion may be connected by a segment of a circle.

In accordance with this exemplary embodiment of the invention, the ring portion may include at least one groove positioned substantially parallel to the driver longitudinal axis, and the at least one groove may have a cross-sectional shape of a segment of a circle in a direction substantially perpendicular to the driver longitudinal axis.

Another exemplary embodiment of the present invention may be directed to a tool kit for use with dental implants that includes an implant holding tool, and an implant driver.

### BRIEF DESCRIPTION OF THE DRAWINGS

Having thus described the invention in general terms, reference will now be made to the accompanying drawings, which are not necessarily drawn to scale, where:

FIG. 1 is a side view of an exemplary embodiment of an implant driver according to the present invention;

FIG. 2 is a rear view of an exemplary embodiment of an implant driver according to the present invention;

FIG. 3 is a front view of an exemplary embodiment of an implant driver according to the present invention;

FIG. 4 is an enlarged front view of an exemplary embodiment of an implant driver according to the present invention;

FIG. 5 is a cross-sectional side view of an exemplary embodiment of an implant driver according to the present invention;

FIG. 6 is an enlarged cross-sectional side view of the tip of an exemplary embodiment of an implant driver according to the present invention;

FIG. 7 is a side view of an exemplary embodiment of an implant holding tool according to the present invention;

FIG. 8 is a cross-sectional side view of an exemplary embodiment of an implant holding tool according to the present invention;

FIG. 9 is a rear view of an exemplary embodiment of an implant holding tool according to the present invention;

FIG. 10 is a front view of an exemplary embodiment of an implant holding tool according to the present invention; and

FIG. 11 an enlarged front view of an exemplary embodiment of an implant holding tool according to the present invention.

### DETAILED DESCRIPTION OF THE INVENTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

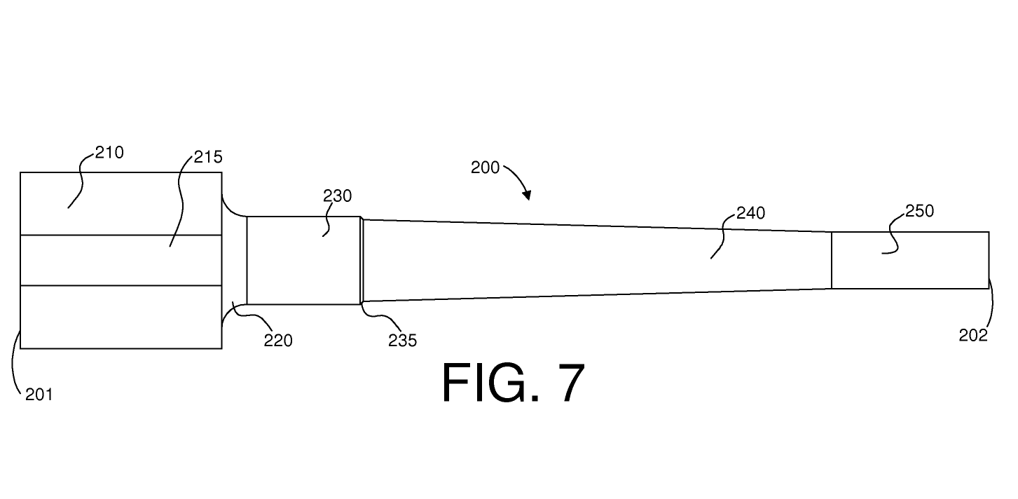

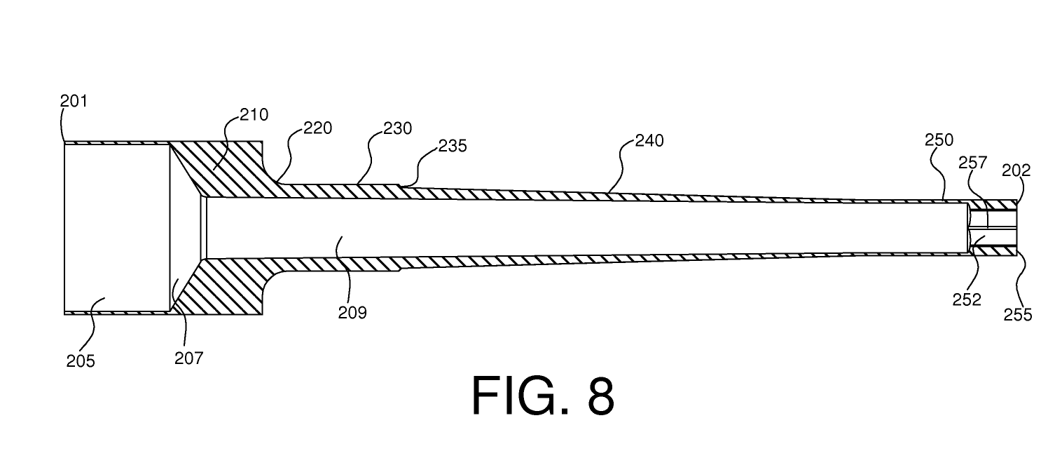

An exemplary embodiment of an implant holding tool 200 according to the present invention is shown in FIGS. 7-11. The implant holding tool 200 includes a first end 201 and a second end 202. Referring specifically to FIG. 8, the second end 202 of the implant holding tool 200 includes an arrangement 255 that is configured to securely engage a dental implant (not shown). While exemplary embodiments of the present invention are discussed with respect to dental implants it is understood that the examples of use are merely exemplary, and embodiments of the present invention may be used for other uses as well. The arrangement 255 defines one opening of a passage that extends along the interior region of the implant holding tool 200 from the second end 202 to the first end 201 of the implant holding tool 200. As shown in detail in FIG. 8, the passage includes a first section 205, a second section 209 and a third section 207, as well as the arrangement 255. The first section 205 of the passage has a larger cross-sectional diameter than the second section 209 of the passage, and the third section 207 may be tapered to join the first section 205 and the second section 209. However, it is understood that the tapered third section 207 may be optional and the first section 205 and second section 209 of the passage may meet at a right angle.

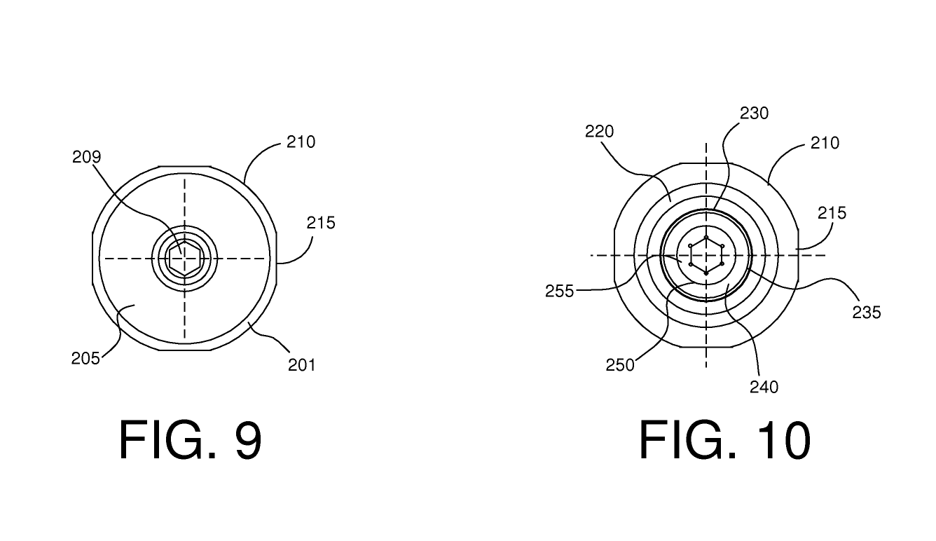

Referring again generally to FIGS. 7-11, the implant holding tool 200 includes an exterior casing surrounding the passage. The exterior casing includes a handle portion 210 positioned at the first end 201 of the implant holding tool 200. The handle portion 210 encompasses at least the first section 205 of the passage, and may also encompass the third section 207 and at least part of the second section 209 of the passage. The handle portion 210 may include one or more regions 215 to facilitate holding and use of the implant holding tool 200. The one or more regions 215 may be substantially flat surfaces positioned on the handle portion 210 or may be concave relative to the handle portion 210. The one or more regions 215 may be positioned lengthwise along the handle portion 210 and substantially parallel to the longitudinal axis of the implant holding tool 200. As shown in FIGS. 9 and 10 for example, the one or more regions 215 may be positioned on opposite sides of the handle portion 210. Referring again generally to FIGS. 7-11, the exterior casing also includes an elongated portion 240 and a tip portion 250. The tip portion 250 may be positioned at the second end 202 of the implant holding tool 200, and may encompass at least a portion of the arrangement 255. The elongated portion 240 may be positioned between the handle portion 210 and the tip portion 250. The elongated portion 240 may also encompass at least a portion of the second section 209 of the passage. The exterior casing of the implant holder tool 200 may also include one or more tapered portions 220, 235 that join together the other portions of the exterior casing due to the differing diameters of the other portions. Positioned between the tapered portion 220, 235 may be a trunk portion 230 that may provide additional rigidity to the exterior casing at the junction between the handle portion 210 and the elongated portion 240.

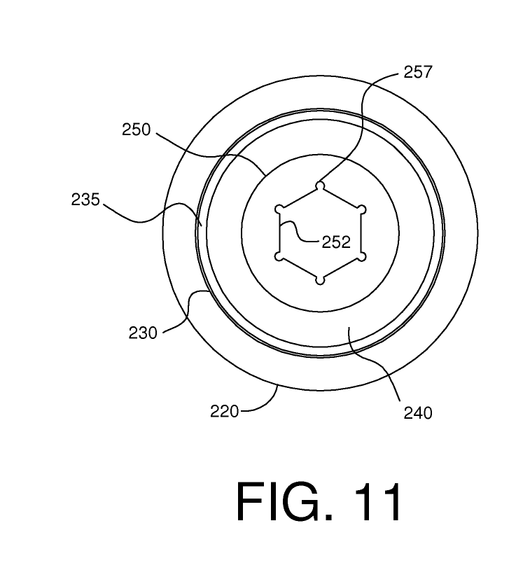

The arrangement 255 that may be positioned at the second end 202 of the implant holding tool 200 includes one or more substantially flat surfaces 252 as shown in FIGS. 8 and 11. In an exemplary embodiment of the present invention, the arrangement 255 may include six substantially flat surfaces 252 arranged in a hexagonal pattern. The substantially flat surfaces 252 extend from the second end 202 of the implant holding tool 200 to the second portion 209 of the passage. The substantially flat surfaces 252 allow for the arrangement 255 to act as a wrench for use on fasteners, bolts, lugs or the like that have a corresponding shape, size and orientation as the arrangement 255. While the exemplary embodiment of the arrangement 255 shown in FIGS. 8 and 11 includes six substantially flat surfaces 252 it is understood that the arrangement 255 may include any number of substantially flat surfaces 252 to make any number of patterns and/or shapes, for example, but not limited to, square, octagonal, hexalobular internal driving feature, triple square, polydrive, spline drive, double hex or the like. Positioned between the substantially flat surfaces 252 of the arrangement 255 may also be relief cuts in the form of grooves 257 that may be positioned substantially parallel to the longitudinal axis of the implant holding tool 200. The grooves 257 may be positioned at what would be the vertices of the cross-sectional pattern formed by the substantially flat surfaces 252, and the grooves 257 may have a cross-sectional form of that of a segment of a circle, for example a semi-circle.

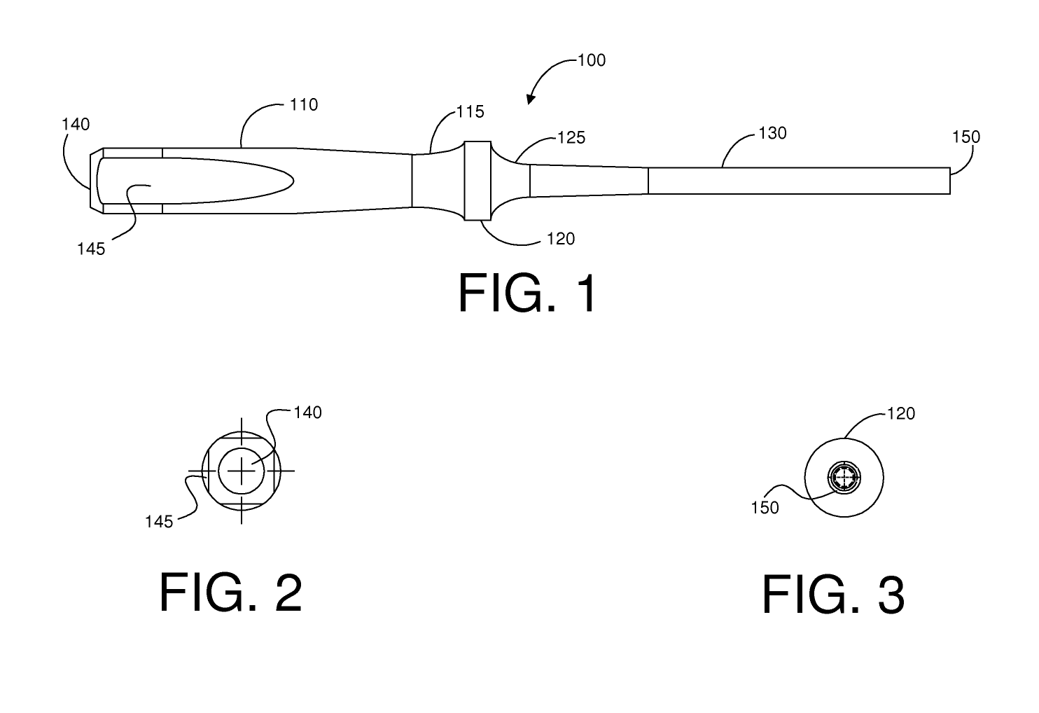

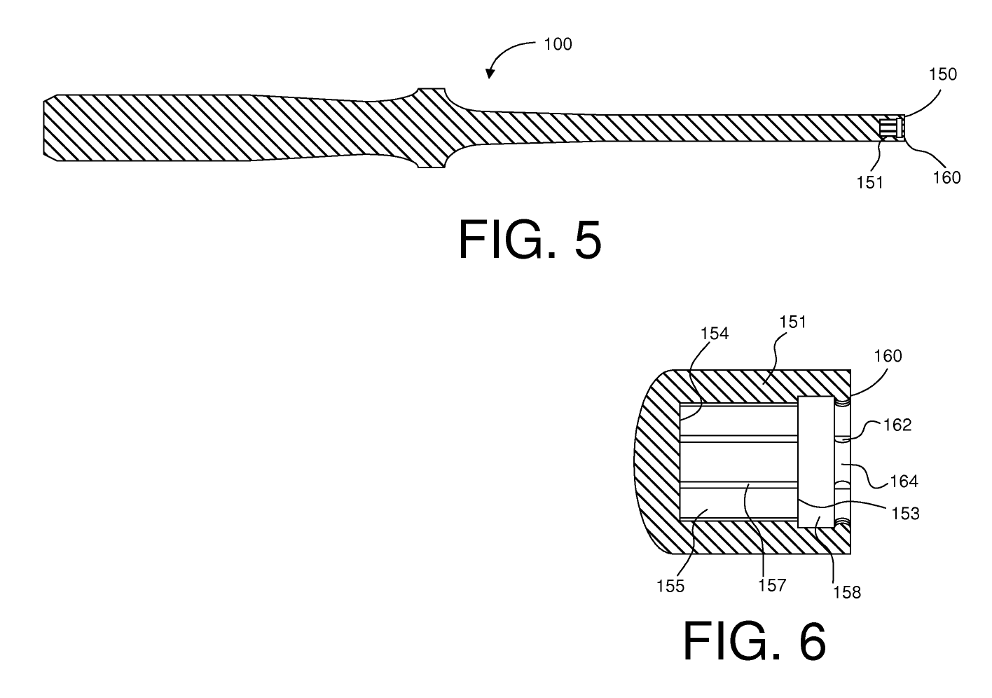

An exemplary embodiment of an implant driver 100 is shown in FIGS. 1-5. As shown in FIG. 1, the implant driver 100 may include a handle at a first end 140 of the implant driver, and the handle may include a handle portion 110, a tapered grip region 115 and a hilt portion 120. The tapered grip region 115 and the hilt portion 120 of the handle provide a surface on which force may be imparted by the user in order to effect use of the implant driver 100. The handle portion 110 may include one or more surfaces 145 that may either be flat or concave relative to the handle portion 110. The one or more surfaces 145 may allow for increased grip and force by a user of the implant driver 100 and/or better tactile feel by the user. As shown in FIG. 2 for example, the one or more surfaces 145 may be positioned on opposite sides of the handle portion 110. Referring again to FIG. 1, the implant driver 100 may also include an elongated portion 130 positioned between the hilt portion 120 of the handle and a second end 150 of the implant driver 100. The elongated portion 130 may be joined to the hilt portion 120 of the handle by a conical portion 125.

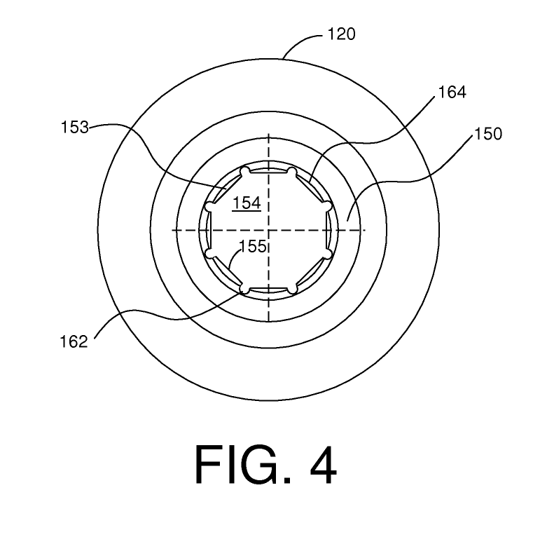

Now referring to FIGS. 4-6, positioned at the second end 150 of the implant driver in the elongated portion 130 may be a socket 151. The socket may include a base 154 and an opening positioned opposite the base 154. One or more substantially flat surfaces 155 may extend from the base 154 towards to the opening. The one or more substantially flat surfaces 155 may be positioned substantially parallel to each other along the longitudinal axis of the implant driver 100. Each of the one or more substantially flat surfaces 155 may be ended by a surface 153 that is positioned substantially perpendicular to each of the substantially flat surfaces 155. While the exemplary embodiment of the socket 151 shown in FIGS. 4 and 6 includes eight substantially flat surfaces 155 it is understood that the socket 151 may include any number of substantially flat surfaces 155 to make any number of patterns and/or shapes, for example, but not limited to, square, hexagonal, hexalobular internal driving feature, triple square, polydrive, spline drive, double hex or the like. A relief cut forming a groove 162 may be made between each substantially flat surface 155. The grooves 157 may be positioned at what would be the vertices of the cross-sectional pattern formed by the substantially flat surfaces 155, and the grooves 157 may have a cross-sectional form of that of a segment of a circle, for example a semi-circle. The opening of the socket 151 may be substantially circular in shape, and may include one or more semi-circular arcs 164 forming a raised region 160 extending inwardly at the opening of the socket 151. The one or more semi-circular arcs 164 may be separated by relief cuts forming grooves 162, and the grooves 162 may have a cross-sectional form of that of a segment of a circle, for example a semi-circle. The raised region 160 and the surface 153 of each substantially flat surface 155 may be separated by a hollow cylindrical region 158.

Now the operation of the implant driver 100 in combination with the implant holding tool 200 will be discussed. The implant driver 100 can be used to engage with an implant, for example a dental implant, by engaging the socket 151 of the implant driver 100 with an implant carrier head (not shown). The implant (not shown) is driven into an osteotomy (not shown) by rotational force imparted by a user on the implant driver 100 being transferred to the implant through the implant carrier head. Once the implant is fully seated and positioned in the appropriate location the implant driver 100 is removed from the implant carrier head. The implant holding tool 200 is then engaged with the implant to hold the implant securely in place. The arrangement 255 of the implant holding tool 200 is used to engage with corresponding surfaces on the implant. The implant driver 100 may then be inserted in the first end 201 of the implant holding tool 200 and through the passage so that the socket 151 of the implant driver 100 is positioned substantially adjacent to the arrangement 255 of the implant holding tool. This positioning allows the implant holding tool 200 to engage the implant, and the implant driver 100 to engage the implant carrier head. The implant driver 100 may then be rotated about its longitudinal axis in the opposite direction that was used to install the implant to remove the implant carrier. The implant holding tool 200 remains secured to the implant during the removal of the implant carrier, and by applying and/or maintaining a force in the opposite rotational direction from the one applied to the implant driver 100 the implant is not loosened from its location. The passage of the implant holding tool 200 is dimensioned so that the implant driver 100 can freely rotate about its longitudinal axis while inserted into the implant holding tool 200.

It is understood that the implant driver 100 and implant holding tool 200 may be made from any suitable material, for example stainless steel or the like. The implant driver 100 and implant holding 200 may be made from surgical stainless steel, for example 17-4 PH stainless steel or the like. In addition, either or both the implant driver 100 and implant holding tool 200 may be heat treated to enhance wear resistance and increase tool life. For example, the implant driver 100 may have a Rockwell C hardness between 48 and 52, and the implant holding tool 200 may have a Rockwell C hardness between 40 and 45.

It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

What is claimed is:

1. A tool, comprising:
a first end,
a second end,
a longitudinal axis,
a body portion comprising an exterior casing and an interior region defined by a passage extending from the first end to the second end of the tool along the longitudinal axis, wherein the passage comprises a first section with a first cross-sectional diameter and a second section with a second cross-sectional diameter, wherein the first cross-sectional diameter is larger than the second cross-sectional diameter, and
an arrangement comprising at least one substantially flat surface positioned at the second end of the tool,
wherein the passage is dimensioned for insertion of a driver comprising a socket into the first end of the tool in a direction substantially parallel to the longitudinal axis of the tool,
wherein the passage is further dimensioned to allow the socket of the driver to be positioned substantially adjacent to the arrangement at the second end of the tool, and
wherein the passage is further dimensioned to allow the driver to rotate within the passage of the tool.

2. The tool according to claim 1, wherein the arrangement comprises at least two substantially flat surfaces, and the at least two substantially flat surfaces are separated by a groove.

3. The tool according to claim 1, wherein the arrangement has a substantially hexagonal cross-section in a direction substantially perpendicular to the longitudinal axis of the tool.

4. The tool according to claim 1, wherein the at least one substantially flat surface of the arrangement originates at the second end of the tool and extends along the passage towards the first end of the tool.

5. The tool according to claim 1, wherein the passage further comprises a third section comprising the arrangement and having a third cross-sectional diameter smaller than the second cross-sectional diameter.

6. The tool according to claim 5, wherein the passage further comprises a fourth section positioned between the first section and the second section, and wherein the fourth section is tapered to join the first section with the second section.

7. The tool according to claim 1, wherein the second section of the passage is positioned substantially concentric with the first section of the passage along the longitudinal axis of the tool.

8. The tool according to claim 1, wherein the exterior casing comprises a first substantially cylindrical region and a second substantially cylindrical region, wherein the first substantially cylindrical region encompasses at least the first section of the passage and the second substantially cylindrical region encompasses at least the second section of the passage.

9. The tool according to claim 8, wherein the first substantially cylindrical region comprises at least one substantially flat surface.

10. The tool according to claim 8, wherein the first substantially cylindrical region comprises at least one substantially concave surface.

11. The tool according to claim 1, wherein the arrangement is configured for engagement with a first plurality of contact surfaces of a fastener, and the socket of the driver is configured for engagement with a second plurality of contact surface of the fastener, wherein when the socket of the driver is positioned substantially adjacent to the arrangement at the second end of the tool, the arrangement is configured to engage the first plurality of contact surfaces of the fastener while the socket is configured to engage the second plurality of contact surfaces of the fastener.

12. The tool according to claim 3, wherein adjacent edges the hexagonal cross-section of the arrangement are connected by a segment of a circle.

13. The tool according to claim 2, wherein the groove has a cross-sectional shape of a segment of a circle in a direction substantially perpendicular to the longitudinal axis of the tool.

14. The tool according to claim 1, wherein the driver further comprises a driver handle, a driver longitudinal axis, and an elongated portion extending from the driver handle along the driver longitudinal axis.

15. The tool according to claim 14, wherein the socket of the driver is positioned at an end of the elongated portion opposite the driver handle.

16. The tool according to claim 14, wherein the driver handle has at least one substantially concave region.

17. The tool according to claim 14, wherein the socket of the driver comprises an opening, a base positioned substantially opposite the opening, an octagonal portion extending from the base, and a ring portion at least partially defining an arc of the opening.

18. The tool according to claim 17, wherein the octagonal portion has a substantially octagonal cross-section in a direction substantially perpendicular to the driver longitudinal axis of the driver, and wherein adjacent edges the octagonal cross-section of the octagonal portion are connected by a segment of a circle.

19. The tool according to claim 17, wherein the ring portion comprises at least one groove positioned substantially parallel to the driver longitudinal axis, and wherein the at least one groove has a cross-sectional shape of a segment of a circle in a direction substantially perpendicular to the driver longitudinal axis.

20. A tool kit for use with dental implants, comprising:
an implant holding tool, and
an implant driver,
wherein the implant holding tool comprises a first end, a second end, a longitudinal axis, a body portion comprising an exterior casing and an interior region defined by a passage extending from the first end to the second end along the longitudinal axis, and an arrangement comprising at least one substantially flat surface positioned at the second end of the implant holding tool,
wherein the implant driver comprises a driver handle, a driver longitudinal axis, and an elongated portion extending from the driver handle along the driver longitudinal axis, and a socket positioned at an end of the elongated portion opposite the driver handle,
wherein the passage of the implant holding tool is dimensioned for insertion of the implant driver into the first end of the implant holding tool in a direction substantially parallel to the longitudinal axis of the implant holding tool,
wherein the passage of the implant holding tool is further dimensioned to allow the implant driver to rotate within the passage of the implant holding tool, and
wherein the arrangement is configured for engagement with a first plurality of contact surfaces of a dental implant fastener, and the socket of the implant driver is configured for engagement with a second plurality of contact surface of the dental implant fastener, wherein when the socket of the implant driver is positioned substantially adjacent to the arrangement at the second end of the implant holding tool, the arrangement is configured to engage the first plurality of contact surfaces of the dental implant fastener while the socket is configured to engage the second plurality of contact surfaces of the dental implant fastener.
